(19) United States
(12) Patent Application Publication
(10) Pub. No.: US 2009/0247339 A1
(43) Pub. Date: Oct. 1, 2009

(54) LINK PLATE FOR A BICYCLE CHAIN

(75) Inventor: CHIH-CHUNG CHIN, Taichung City (TW)

Correspondence Address: Chien-Hui Su, P. O. Box 70-121 Taichung, Taichung City, 40899, TW

(73) Assignee: TIEN HSIN INDUSTRIES CO., LTD., TAICHUNG CITY (TW)

(21) Appl. No.: 12/057,388

(22) Filed: Mar. 28, 2008

(51) Int. Cl. F16G 15/12

(52) U.S. Cl. 474/206

(57) ABSTRACT

A link plate for a bicycle chain comprises a plate having a first end and a second end. The first end includes an installation hole and an elongated opening. The installation hole includes a first aperture and a second aperture connected to the first aperture. A peak portion is defined between the first aperture and the second aperture to prevent movement of a pin from the second aperture to the first aperture easily. The elongated opening is connected to the first aperture to expand the installation hole slightly as the pin moves from the first aperture to the second aperture.

### FIELD OF THE INVENTION

The present invention relates to a link plate for a bicycle chain, and particularly to a high strength link plate assembly which minimizes the possibility of accidental disengagement and is easy to assemble and disassemble.

### BACKGROUND OF THE INVENTION

Referring to U.S. Pat. No. 5,291,730, “knuckle connector for connecting end knuckles of a chain strand” is disclosed, in that a knuckle connector is provided, which includes a pair of link units, each of which has a link pin and an oval-shaped link plate formed with a circular through-hole on one end and a retaining hole on an opposite end. The link pin has a head secured in the through hole and a tail end formed with a peripheral channel. The link pin of one of the link units extends through a pin hole formed in a corresponding one of the end knuckles such that the peripheral channel initially extends into a large insert part of the retaining hole in the link plate of a remaining one of the link units. The peripheral channel of the link pin of one of the link units engages the link plate of the remaining one of the link units in a diameter-reduced retaining part of the retaining hole when the end knuckles are pulled apart. The link plate of each link unit is provided with an inclined stop member that includes a cantilevered tab and terminates at an end knuckle abutment face. The inclined stop member is formed by punching the link plate at one side of the insert part of the retaining hole opposite to the retaining part. The stop members of the link plates extend into a space between the end knuckles and face a respective one of the end knuckles. The stop members prevent movement of the end knuckles toward one another.

Above mentioned structure provides the stop members for preventing movement of the end knuckles toward one another, it still has some drawbacks. First, the prior art doesn't overcome the problem of disengagement. An elongated slot which is the same width with the diameter-reduced retaining hole forms between the large insert part and the diameter-reduced retaining hole. So the pin can slide between the large insert part and the diameter-reduced retaining hole. It will increase the possibility of disengagement. Second, the prior art has the problem of strength. The cutting-off area of the plate is increasing due to the inclined stop member and the elongated slot. The strength of the plate will decrease. Third, the inclined stop member will interfere with other parts that will increase the noise and affect the smoothness of transmission.

### SUMMARY OF THE INVENTION

Accordingly, the primary object of the present invention is to provide a link plate for a bicycle chain, wherein the structure is simple so that the rider and user can assemble or disassembly the chain easily and quickly. Furthermore high strength and anti-disengagement structure is provided.

To achieve above objects, the present invention provides a link plate for a bicycle chain, comprising: a plate having a first end and a second end, the first end having an installation hole and an elongated opening, the installation hole including a first aperture and a second aperture connected to the first aperture, a peak portion defined between the first aperture and the second aperture to prevent movement of a pin from the second aperture to the first aperture easily, the elongated opening being connected to the first aperture to expand the installation hole slightly as the pin moves from the first aperture to the second aperture, the second end secured with a pin, the pin having a head portion and a groove portion, wherein a diameter of the second aperture is less than a diameter of the first aperture, the second aperture includes a countersink, a width of the countersink is equal to a diameter of the first aperture.

The various objects and advantages of the present invention will be more readily understood from the following detailed description when read in conjunction with the appended drawing.

### BRIEF DESCRIPTION OF THE DRAWINGS

FIG. 1 is an exploding view of a link plate assembly for a bicycle chain according to the present invention.

FIG. 2 is a side view of the link plate according to the present invention.

FIG. 3 is a side view of the link plate assembly which shows the pin inserted into the first aperture.

FIG. 4 is a side view of the link plate assembly which shows the pin pushed into the second aperture.

FIG. 5 is a perspective view of the link plate assembly according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

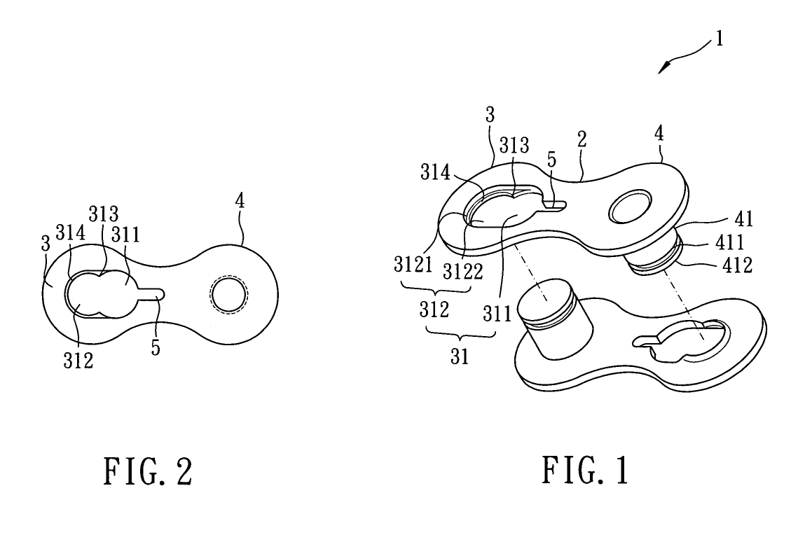

With reference to FIGS. 1 and 5, a link plate assembly of the present invention is illustrated. The link plate assembly includes a pair of link plates 1.

Referring to FIGS. 1 and 2, each of the link plates 1 includes a plate 2 and a pin 41. The plate 2 includes a first end 3 and a second end 4. The first end 3 forms an installation hole 31 and an elongated opening 5. The installation hole 31 includes a first aperture 311 and a second aperture 312. A diameter of the second aperture 312 is less than a diameter of the first aperture 311 and the second aperture 312 is connected to the first aperture 311. Two peak portions 313 is defined between the first aperture 311 and the second aperture 312 so the distance between the peak portions 313 is small than any one of the diameter of the second aperture 312 and the diameter of the first aperture 311. The second aperture 312 forms a countersink 314 so the second aperture divides into an upper portion 3121 and a lower portion 3122. A width of the countersink 314 (same as the upper portion 3121) is equal to the diameter of the first aperture 311. The elongated opening 5 is connected to the first aperture 311 and is positioned in a line extending from center of the first aperture 311 to center of the second aperture 312. A width of the elongated opening 5 is very less than the diameter of the first aperture 311. The second end 4 is secured with the pin 41. The pin 41 includes a head portion 412 and a groove portion 411. The diameter of the first aperture 311 is equal or greater than a diameter of the head portion 412. The diameter of the second aperture 312 (same as the lower portion 3122) is equal to or greater than a diameter of the groove portion 411 and is less than the diameter of the head portion 412.

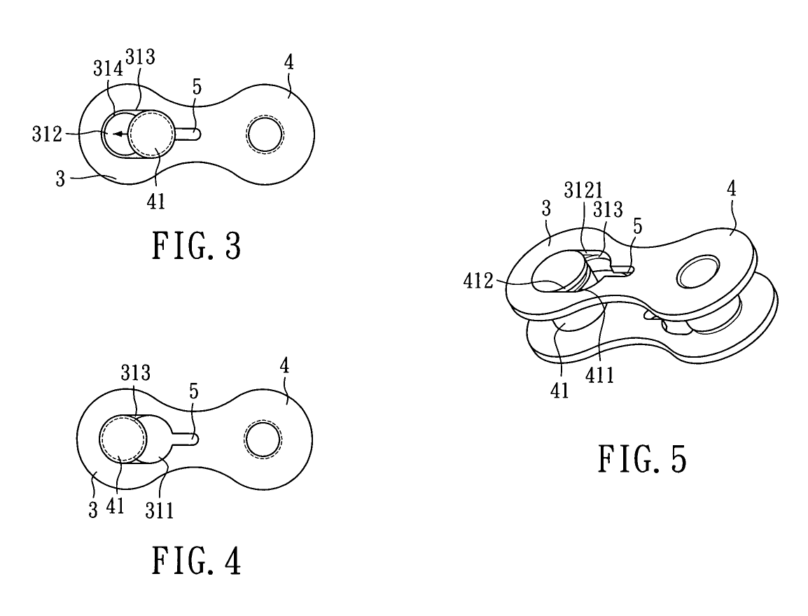

To assemble the link plate assembly, the pin 41 of one link plate 1 is inserted into the first aperture 311 of the other link plate 1 as shown in FIG. 3. The head portion 412 passes through the first aperture 311. Keep the peak portion 313 contacting with the groove portion 411 and then push the pin 41 toward the second aperture 312. The installation hole 31 will be expanding slightly due to the elongated opening 5. So the groove portion 411 is pushed into the second aperture 312 and the head portion 412 moves along the upper portion 3121 as shown in FIG. 4. The head portion 412 engages with the lower portion 3122 so the axial movement of pin 41 is constrained (FIG. 5). Since the distance between the peak portions 313 is small than the diameter of the groove portion 411, the peak portion 313 prevents movement of the pin 41 from the second aperture 312 to the first aperture 311. Therefore the possibility of accidental disengagement is minimized.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A link plate for a bicycle chain, comprising:
a plate having a first end and a second end, the first end having an installation hole and an elongated opening, the installation hole including a first aperture and a second aperture connected to the first aperture, a peak portion defined between the first aperture and the second aperture to prevent movement of a pin from the second aperture to the first aperture, the elongated opening being connected to the first aperture to expand the installation hole slightly as the pin moves from the first aperture to the second aperture.

2. The link plate as claimed in claim 1, wherein the second end is secured with a pin, the pin includes a head portion and a groove portion.

3. The link plate as claimed in claim 1, wherein a diameter of the second aperture is less than a diameter of the first aperture.

4. The link plate as claimed in claim 1, wherein the second aperture includes a countersink, a width of the countersink is equal to a diameter of the first aperture.

5. The link plate as claimed in claim 1, wherein the elongated opening is positioned in a line extending from center of the first aperture to center of the second aperture.

6. A link plate assembly for a bicycle chain, comprising:
a pair of plates, each of the plates having a first end and a second end, the first end having an installation hole and an elongated opening, the installation hole including a first aperture connected to the elongated opening and a second aperture connected to the first aperture, a peak portion defined between the first aperture and the second aperture;
a pair of pins, each of the pins secured with the second end of each plate, the pin having a head portion and a groove portion; and
wherein a diameter of the first aperture is equal or greater than a diameter of the head portion, a diameter of the second aperture is equal to or greater than a diameter of the groove portion, but the diameter of the second aperture is less than the diameter of the first aperture, the elongated opening expands the installation hole slightly as the groove portion moves from the first aperture to the second aperture, the peak portion prevents movement of the pin from the second aperture to the first aperture.
